(19) United States
(12) Patent Application Publication
(10) Pub. No.: US 2023/0408389 A1
(43) Pub. Date: Dec. 21, 2023

(54) A PIPE TESTING APPARATUS AND METHOD

(71) Applicant: VERDERG PIPE TECHNOLOGY LIMITED, WOKING SURRY (GB)

(72) Inventor: Peter Roberts, Woking (GB)

(21) Appl. No.: 18/036,202

(22) PCT Filed: Oct. 22, 2021
(86) PCT No.: PCT/GB2021/052745

§ 371 Date: May 10, 2023

(30) Foreign Application Priority Data
Nov. 10, 2020 (GB) 2017699.6

(51) Int. Cl. G01N 3/12; G01N 1/04

(52) U.S. Cl. CPC G01N 3/12; G01N 1/04; G01N 2203/0274

(57) ABSTRACT

An apparatus for testing a ring cut from a pipe, comprising: a body, an annular pressure member, which is expandable and is connected to a source of pressurised fluid, and one or more sensors for measuring strain and deformation of the ring and fluid pressure, wherein the body defines a substantially circular opening for receiving the annular pressure member and the ring, and the annular pressure member is provided, in use, between an inner surface of the substantially circular opening and an outer circular surface of the ring for applying pressure to the outer circular surface of the ring.

The present disclosure relates to an apparatus for testing pipes such as those used for forming underwater pipelines and to a method of pipe testing using the apparatus.

There has been a progressive development of very deep water reservoirs of gas and/or oil around the world. Until quite recently, very deep water was defined to be any depth greater than about 1000 m. However, so many pipelines have been installed in depths greater than this that the definition of very deep water is now beyond 2000 m.

The pipelines are typically installed empty, i.e. filled with air at ambient pressure and only filled with oil or gas under pressure once installation is completed. A major risk experienced during the installation of these deep-water pipelines is from the pressure applied by the water causing the pipe to deform out of its initial round shape and deform into an almost flat configuration. This is called external pressure collapse and if not controlled can result in the total loss of the pipeline. The dimensions, i.e. diameter and wall thickness, and also the material properties, of a very deep-water pipeline are therefore constrained by the potential for external pressure collapse.

This is in complete contrast to the design of a conventional shallow-water or onshore pipeline where the wall thickness is sized to resist internal pressure from the fluid it is to carry rather than external pressure.

Various theoretical studies of external pressure collapse have been carried out and numerical modelling has also been used to calculate the maximum water depth at which a pipeline with specified dimensions can safely be installed. However, the consequences of external pressure collapse are so great that these theoretical studies are not sufficient for confident management of the risk. Also, the most important method for reducing the potential for such local collapse, by increasing the wall thickness of the pipe, is so expensive and possibly not technically realisable, that the proposed pipeline might well not be commercially feasible. This in turn raises the possibility that the exploitation of the gas or oil reservoirs are abandoned.

The alternative to basing all design on the results from theory is to additionally carry out tests. Indeed, historically, several tests were carried out for a range of pipe wall thicknesses. These tests involved placing a complete pipe length of specially fabricated pipe in special pressure chambers and increasing the external pressure until collapse occurred. There remain a very limited number of laboratories with suitable facilities available and the tests are very expensive.

Codes have been prepared to provide a basis for the calculation of the dimensions for pipes that are required to operate at specified great depths. These codes encompass safety factors that are intended to ensure that the natural variations in pipe dimensions and material properties that occur during the manufacture of a pipeline that could be 1000 km long will not undermine the capacity of the pipeline to withstand the external pressure without collapse occurring. However, the factors are based on the few previous available complete pipe length collapse tests; the possibility of carrying out such tests on complete pipe lengths (otherwise known in the industry as “pipe joints”) during fabrication of the pipe are not realistic since the tests take a significant time to be set up and completed and of course such tests destroy the tested pipe.

Only one pipe joint of a pipeline needs to collapse to flood the whole line. There is a direct analogy with “the weakest link in the chain” as regards pipeline failure due to external pressure collapse. Given that the codes of practice were based on the collapse test results of a small finite number of joints of line pipe, the design codes introduce a factor to allow for all possible variation of the many factors that affect the collapse pressure to increase the wall thickness down the whole deepwater route.

More recently improved test methods have been developed aimed at replicating the effects of external pressure to cause the collapse of pipe joints and which are easy (and dramatically more cost effective than the historical test methods) to set up and complete.

These improved test methods are based on the recognition that the deformations that lead to external pressure collapse are uniform along the pipe and that therefore the occurrence of external pressure collapse will be the same for a ring cut from the pipe as for the complete pipe joint length of pipe that is subjected purely to external pressure.

A prior art pipe testing apparatus for use implementing the improved test methods is known from WO 2008/114049.

This pipe testing apparatus has proved highly effective for testing pipes used for forming underwater pipelines. There is, however, a level of expertise and precision required in the implementation of these test methods. The tests are typically conducted in pipe testing laboratories by highly skilled technicians.

The present invention arose in a bid to provide an improved pipe testing apparatus allowing for the non-destructive testing of pipes that could be implemented effectively outside of dedicated testing laboratories, allow for accurate repeatable operation by less-skilled individuals, and allow for a higher throughput of test specimens.

Representative features are set out in the following clauses, which stand alone or may be combined, in any combination, with one or more features disclosed in the text and/or drawings of the specification.

According to the present invention in a first aspect, there is provided an apparatus for testing rings cut from pipes, comprising: a body, an annular pressure member, which is expandable and is connected to a source of pressurised fluid, and one or more sensors for measuring strain and deformation of the ring and fluid pressure, wherein the body defines a substantially circular opening for receiving the annular pressure member and the ring, and the annular pressure member is provided, in use, between an inner surface of the substantially circular opening and an outer circular surface of the ring for applying pressure to the outer circular surface of the ring.

The annular pressure member is a distinct fluid-filled member. It is radially expandable. It preferably comprises a closed hollow ring.

The body is preferably axially open. There is preferably substantially no axial loading of the ring. The apparatus is preferably configured to apply pressure to the outer circular surface of the ring only.

According to the present invention in a further aspect, there is provided a method of testing a ring cut from a pipe using the apparatus specified above, the method comprising:
a. cutting the ring from the pipe;
b. Fitting the ring into the apparatus; and
c. Applying pressure using the apparatus and recording the strain and deformation measurements.

Further, preferable features are presented in the dependent claims.

It is to be noted that the principles of the present invention may be applied to the testing of pipes having a wide range of diameters and wall thicknesses, and the present invention is not to be limited in this regard.

Non-limiting embodiments of the invention will now be discussed with reference to the following drawings:

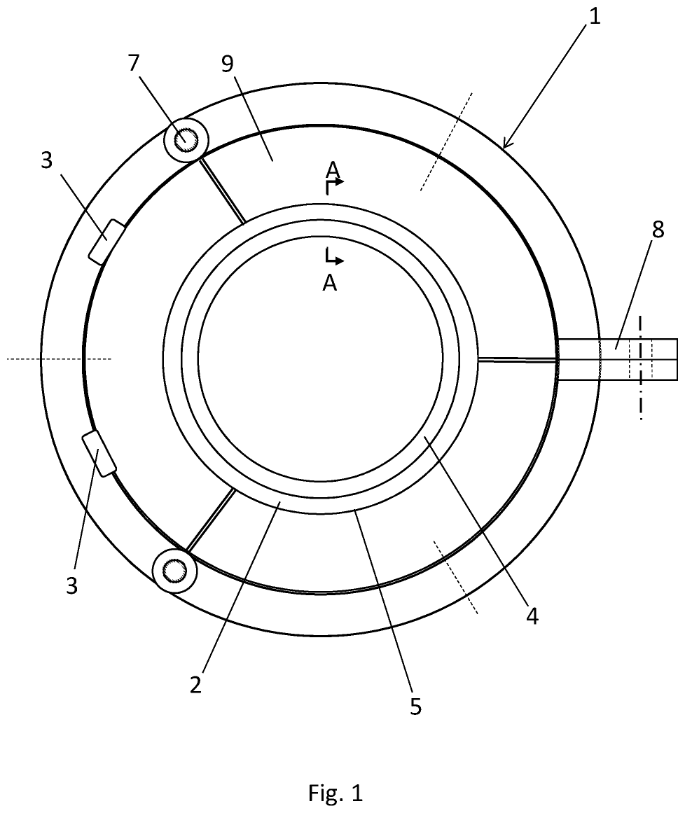

FIG. 1 shows a schematic plan view of a testing apparatus according to a first embodiment with a ring to be tested in situ;

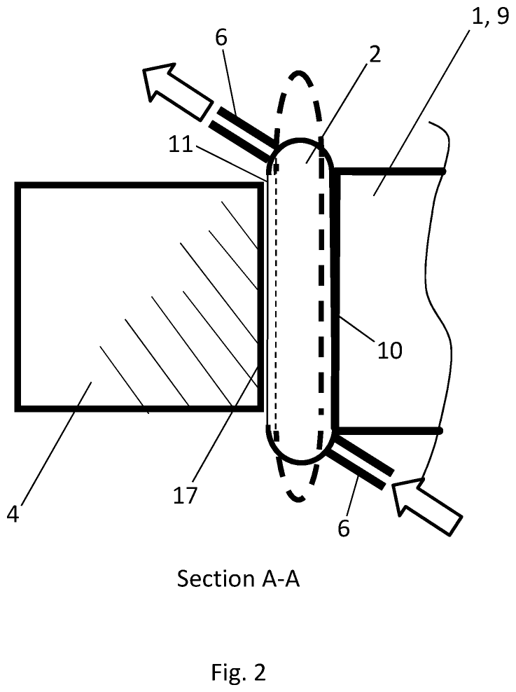

FIG. 2 shows a schematic sectional view taken through A-A in FIG. 1; and

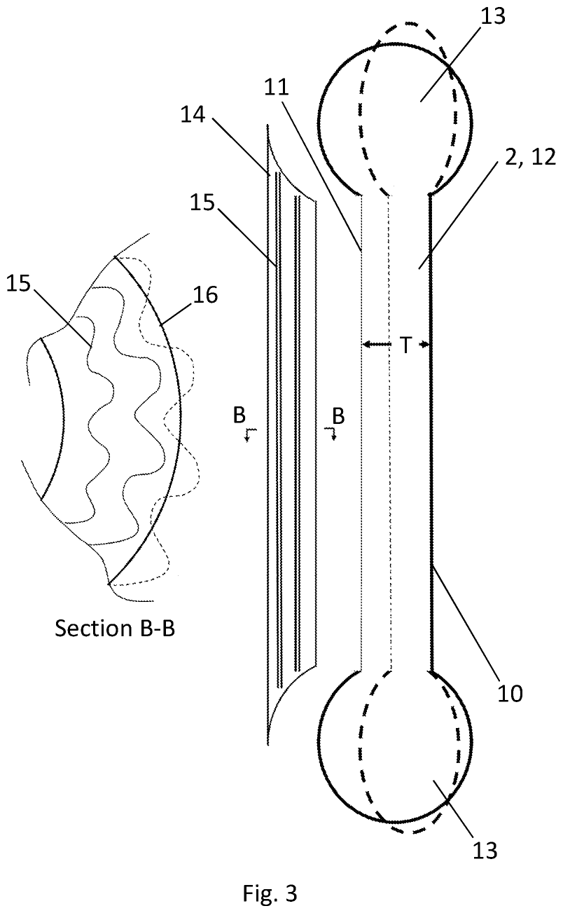

FIG. 3 shows a schematic sectional expanded view of a pressure collar and associated gasket according to a possible embodiment along with a schematic sectional view of the gasket taken through B-B.

Tests on long sections of individual pipe joints have shown that the deformations that lead to external collapse are uniform along the pipe. This observation is supported by theoretical studies and numerical modelling. The implication is that the occurrence of external pressure collapse will be the same for a ring cut from the pipe as for the complete joint length of pipe that is subjected purely to external pressure. The testing approach of the invention is therefore based on cutting short sections from a pipe. The ring is placed in a novel testing apparatus such that a pressure can be applied only to the outer circular surface of the ring. Devices are provided to measure the strains and deformations that are caused by the pressure on the outer circular surface of the ring.

The pressure is applied from an external pump such that the pressure is increased by the addition of a specified volume of fluid to the pressure member, which surrounds the outer circular surface of the ring. This arrangement allows for radial deformations of the ring caused by the controlled expansion of the pressure member.

A typical test will involve the following steps:
a. cutting the ring from the pipe;
b. Fitting the ring into the apparatus; and
c. Applying pressure using the apparatus and recording the strain and deformation measurements.

It may be useful to also plot a curve of pressure applied against maximum strain measured to detect the onset of an accelerating non-linear reduction in ring diameter with increasing pressure.

With reference to FIGS. 1 and 2, there is shown a testing apparatus comprising a body 1, an annular pressure member 2, which is expandable and is connected to a source of pressurised fluid (not shown), and one or more sensors 3 for measuring strain and deformation of a ring 4 and fluid pressure. The body defines a substantially circular opening 5 for receiving the annular pressure member 2 and the ring 4. The annular pressure member 2 is provided, in use, between an inner surface of the substantially circular opening 5 and an outer circular surface of the ring 4, as clearly shown. The annular pressure member 2 applies pressure to the outer circular surface of the ring 4 by its radial expansion.

The form of the body 1 is not particularly limited. It must allow for the provision of the substantially circular opening 5 and be further configured to allow for insertion of the annular pressure member 2 and the ring 4. The body may comprise a clamp. This is preferable as it provides a simple structure that may be opened up for ready insertion of the annular pressure member 2 and the ring 4, whilst providing the required circular opening and suitable resistance to deformation during testing. It may comprise two or more curved hinged portions. In the present arrangement there are three curved hinge portions, as clearly seen in FIG. 1, joined via hinges 7 and closed by a clamping/locking portion 8. There may be more or less hinged portions in alternative arrangements. The hinged portions need not be particularly limited in form and need not be restricted to the form shown. The body may comprise a plurality of curved anchor blocks 9 that are received by the clamp and define the inner surface of the substantially circular opening 5. By use of anchor blocks 8, the body 1, and specifically the substantially circular opening 5 defined thereby, may be varied in size by swapping out the anchor blocks 9 for different sized anchor blocks, allowing ready adaption of the apparatus to rings having different diameters. As will be appreciated, alternative arrangements may omit the anchor blocks 9.

The number, position and form of the sensors 3 is not particularly limited. There are preferably separate pressure sensors and strain/deformation sensors, although in some arrangements these may be combined. One or more sensors is preferably fixed to the body such that a force caused by radial expansion of the annular pressure member 2 is transmitted thereto via the anchor blocks 9 (in the present arrangement) or otherwise. In the present arrangement load cells 3 are provided between the anchor blocks 9 and the body 1. The provision of such load cells allows for a cross-check on the pressure reading by any pressure sensors, ensuring for example that the anchor blocks 9 are not touching each other. It is preferable that each of the anchor blocks 9 comprises one or more load cells 3 associated therewith.

The annular pressure member 2 is a distinct member and preferably comprises a closed hollow ring, as shown. It may be formed from stainless steel or any alternative suitable materials, as will be apparent to those skilled in the art. The pressure member 2 according to the arrangement of FIGS. 1 and 2 is closed except for provided fluid inlet/outlets 6. In the present arrangement there is an inlet provided separately to an outlet, these may be combined in other arrangements, i.e. there may be a single opening for the introduction and expulsion of fluid from the pressure member 2. The form of any opening/inlet/outlet is not particularly limited and may take any conventional form, as will be readily appreciated by those skilled in the art. One or more suitable pumps/valves may be provided for controlling the flow of pressurised fluid in/out of the pressure member 2 and the pressure of the fluid within and expansion of the annular pressure member 2, again as will be readily appreciated by those skilled in the art.

The annular pressure member 2 is shown in solid lines in an expanded state in FIG. 2, wherein the broken lines are indicative of the form of the annular pressure member 2 prior to such expansion. In the present arrangement, as shown, a wall of the annular pressure member is thicker in a region defining a first (outer) surface 10 for engaging the inner surface of the substantially circular opening than in a region defining a second (inner) surface 11 for engaging the outer circular surface 17 of the ring 4. This need not be the case but is preferable. Notably, a reduced wall thickness increases flexibility. The first surface and the second surface 10, 11 are preferably parallel to one another. The first surface and second surface 10, 11, irrespective of whether they differ in thickness, preferably have a width/axial length equal or greater than the width/axial length of the ring 4 and the contact portion of the body 1. The annular pressure member 2 may have an elongated oval profile, as shown in FIG. 2, or may be otherwise formed, as also discussed below.

The first and second surfaces 10, 11 may be spaced by a predetermined distance, which is set based on an anticipated collapse pressure of the sample ring 4, such that the circumferential Poisson shrinkage of the second surface 11 results in the circumference of the second surface 11 substantially equalling the reduced circumference of the outer circular surface 17 of the ring at the onset of failure. The outer diameter of the ring reduces under load controlling shrinkage of the circumference of the annular pressure member 2 second surface 11. The distance between the first and second surfaces determines the lateral tension in the second surface 11 which in turn controls the Poisson reduction in circumference of the second surface 11. Accordingly, the spacing between the first and second surfaces 10, 11 and the thickness of the wall of the annular pressure member 2 in the region of the second surface 11 may be chosen so the second surface 11 of the annular pressure member 2 shrinks under the Poisson effect by the same amount as the specimen circumference to eliminate or minimise the second surface 11 going into compression.

Following on from the above discussion, as will be readily appreciated by those skilled in the art, the thickness T can be selected to control the required circumferential Poisson shrinkage in the inner surface 11. As the annular pressure member 2 expands and more fluid is pumped in, the pressure is maintained or deliberately raised towards the failure pressure. However, as T increases in this manner although the pressure might well remain constant or only rise slowly, the lateral tension rises directly in proportion to the increase in T. For a unit circumferential length of pressure element, this total lateral tension equals [T*pressure], shared between faces 10 and 11.

The lateral strain in surface 11 is controlled linearly by the tension in surface 11 and the circumferential Poisson shrinkage in surface 11 (and therefore the radial shrinkage) is linearly controlled in turn by the lateral strain.

So, as again will be appreciated by those skilled in the art, the initial distance between the surfaces 11, 12 before the test, is set by prior calculation based on experience of previous tests to increase during the test to a separation T where the consequent lateral tension in surface 11 induces a circumferential shrinkage strain in face 11 approximately equal to the shrinkage in the circumference of the opposed surface (specimen of gasket) at the point when the ring “fails” and the test completes.

With reference to FIG. 3, there is shown an alternative form of annular pressure member 2, which, in cross-section, comprises a central portion 12 and enlarged end portions 13, which have a greater thickness than the central portion. The enlarged end portions are preferably bulbous. The central portion 12 preferably has a width substantially equal to or greater than the width/axial length of the ring 4 being tested. The first surface and second surface 10, 11 may differ in thickness as described above. The first and second surfaces 10, 11 are again preferably substantially parallel to one another.

Having enlarged/bulbous ends increases the flexibility of the pressure member 2 permitting the same pressure member 2 to be used with varying ring diameters (and anchor block widths) to vary a radial dimension of the pressure member 2. Moreover, as the size of the enlarged end portions 13 increases, the flexibility increases and the force needed to vary the distance between the first and second surfaces 10, 11 reduces. This helps to maximise the percentage of the applied pressure that actually bears onto the specimen rather than be reacted by the elements of the apparatus.

Further shown in FIG. 3 is an annular gasket 14, which is arranged to be located between the annular pressure member 2 and the ring 4 in use. The annular gasket 14 is preferably formed from a resilient material. It may be rubber or otherwise. It preferably comprises one or more layers 15 of reinforcing material, which are spaced from one another in a thickness direction of the gasket 14. The reinforcing layers are preferably sheet-like in form. In the arrangement of FIG. 3, as seen in section B-B (not to scale), there are shown to be two layers 15, however, there may be more layers 15 or a single layer only. The layers 15 of reinforcing material may undulate in a circumferential direction, as shown. The layers 15 give the gasket 14 substantial stiffness under through-thickness compression and lateral expansion. By the wavy/undulating shape, however, they have very little circumferential stiffness permitting diameter reduction of both the ring 4 and the inner/second surface 11 under hydrostatic radial pressure with minimal dissipation of the applied pressure due to circumferential compression forces induced into the rubber gasket.

An outer surface 16 of the gasket may also undulate, as indicated by the broken line in the section B-B image. The dimensions of the undulation may be chosen such that during compression, the inner/second surface 11 of the originally un-rippled pressure member 2 is forced down into the troughs of the undulations such that minimal/nominal compressive strain is induced into the second surface 11.

It is to be noted that whilst the gasket 14 is discussed in the context of an annular pressure member 2 having enlarged end portions, it need not be limited as such and may be used in combination with annular pressure members 2 of different form, including that discussed with respect to FIG. 2. Its form may be adapted accordingly, as will be appreciated by those skilled in the art.

In the context of the arrangement of FIG. 3, for the gasket to be inserted between the enlarged end portions 13, it can be crippled into a folded shape and inserted into the space between there between. The ring 4 may then be slipped inside the gasket 14. The gasket preferably fills the void between the enlarged end portions to present a planar/flush inner face.

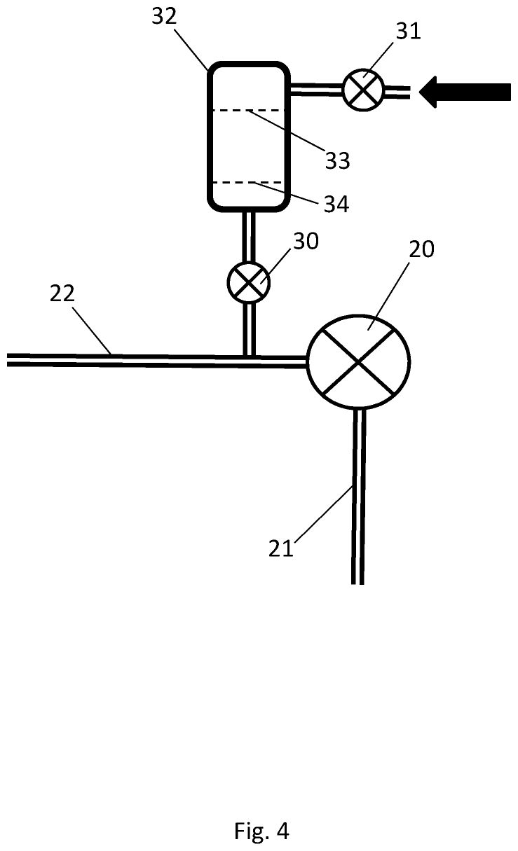

With reference to FIG. 4, there is shown a further, optional arrangement, which may be applied in respect of any of the above described arrangements. This represents the optional introduction of an accumulator 32 into a pressurization system (which comprises the source of pressurised fluid), to permit variation in the “hydraulic stiffness” of the pressurization system. In alternative arrangements, the accumulator may be omitted from the pressurisation system.

FIG. 5, as will be appreciated, shows a schematic arrangement for illustration purposes only. The pressurisation system preferably comprises a pump 20, which receives fluid through an inlet line 21 for injection into the system through pressurising line 22.

The introduction of the accumulator 32 provides a means to vary the stiffness of the pressurizing system to enhance the visibility of a “permanent distortion limit”, i.e. when the non-recoverable plastic strain caused by a standard increment of pressure exceeds a pre-defined acceptance level. This is of value where such permanent distortion to the pipe cross-section is the chosen practical acceptance threshold beyond which the level of permanent distortion of the pipe cross-section is considered to be unacceptable for practical reasons even though pipe integrity has not been breached.

As will be clear from the discussion that follows, the form of the accumulator 32 is not particularly limited. Any conventional gas-backed accumulator, for example, may be implemented as will be readily appreciated by those skilled in the art.

With reference to the arrangement of FIG. 5, when valve 30 is closed, the system has unchanged maximum stiffness and pressure increments are relieved by very small strains. Opening valve 30 and charging the accumulator 32 with compressed gas (such as, but not limited to any one of dry air, nitrogen or carbon dioxide), by opening the valve 31, to, say, a first level (indicated by broken line 33), provides some more system flexibility where a standard increment of pressure will require some more strain to relieve. Increasing the gas pressure further will drive down the fluid to, say, a second level (indicated by broken line 34), where the greater gas volume provides even more flexibility, whereby a standard system pressure rise, matched by a gas pressure rise to sustain the second level, will require even more strain of the specimen ring to relieve. This means that the sensitivity with which an operator can detect the “permanent distortion limit” described below may be usefully enhanced, permitting a quicker and easily managed non-destructive testing process.

As will be appreciated by those skilled in the art, the accumulator may take any suitable known form.

Methods and apparatus according to the invention demonstrate a number of advantages over previous techniques. They allow testing of a representative sample of test rings taken from all the line pipe joints required for a long pipeline to give direct physical quantified evidence of the capacity of each of these specimens to resist external hydrostatic collapse. The collapse tolerance of each specimen test ring can be confidently held to be representative of the collapse tolerance of the joint from which it is cut. Use of the invention in the manner described can permit a reduction in the factor used currently in the design process to increase the wall thickness of the whole line. The joint from which each test ring is cut can still be utilized as a production joint and is not wasted. The net result can be a highly significant reduction in pipeline wall thickness that will provide improved commercial availability of line pipe and significant cost savings. Over the referenced prior art, they provide for accurate repeatable operation by less-skilled individuals, and allow for a higher throughput of test specimens. This allows for the implementation of testing of many samples at source, in a pipe mill as part of the production process, or otherwise. The disclosed apparatus also allows for multiple tests to be performed without any component being changed.

Numerous alternative arrangements and modifications to the apparatus as described herein will be readily appreciated by those skilled in the art within the scope of the appended claims.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. An apparatus for testing a ring cut from a pipe, comprising:
a body,
an annular pressure member, which is expandable and is connected to a source of pressurised fluid, and
one or more sensors for measuring strain and deformation of the ring and fluid pressure,
wherein the body defines a substantially circular opening for receiving the annular pressure member and the ring, and the annular pressure member is provided, in use, between an inner surface of the substantially circular opening and an outer circular surface of the ring for applying pressure to the outer circular surface of the ring.

2. The apparatus of claim 1, wherein the annular pressure member comprises a closed hollow ring.

3. The apparatus of claim 1, wherein the annular pressure member is formed from stainless steel.

4. The apparatus of claim 1, wherein the annular pressure member, in cross-section, comprises a central portion and enlarged end portions, which have a greater thickness than the central portion.

5. The apparatus of claim 4, wherein the central portion has a width substantially equal to or greater than the length of the ring being tested.

6. The apparatus of claim 1, wherein a wall of the annular pressure member defines a first surface for engaging the inner surface of the substantially circular opening and a second surface for engaging the outer circular surface of the ring.

7. The apparatus of claim 6, wherein the first and second surfaces are substantially parallel to one another.

8. The apparatus of claim 6, wherein the first and second surfaces are spaced by a predetermined distance, the predetermined distance is set based on an anticipated collapse pressure, such that the circumferential Poisson shrinkage of the second surface results in the circumference of the second surface substantially equalling the reduced circumference of the outer circular surface of the ring at the onset of failure.

9. The apparatus of claim 6, wherein the second surface is thinner than the first surface.

10. The apparatus of claim 1, further comprising an annular gasket located between the annular pressure member and the ring in use.

11. The apparatus of claim 10, wherein the annular gasket is formed from a resilient material and comprises one or more layers, in a thickness direction, of reinforcing material.

12. The apparatus of claim 11, wherein the layers of reinforcing material are undulating in a circumferential direction.

13. The apparatus of claim 10, wherein an outer circular surface of the gasket is undulating in a circumferential direction.

14. The apparatus of claim 10, wherein the annular pressure member, in cross-section, comprises a central portion and enlarged end portions, which have a greater thickness than the central portion, and wherein the gasket is configured to fill a void defined by the thinner central portion.

15. The apparatus of claim 1, wherein the body comprises a clamp.

16. The apparatus of claim 15, wherein the clamp comprises two or more curved hinged portions.

17. The apparatus of claim 1, wherein the body comprises a plurality of curved anchor blocks that define the inner surface of the substantially circular opening.

18. The apparatus of claim 17, wherein each of the anchor blocks comprises at least one load cell, which is arranged to lie between the anchor block and the body for measuring a load on the annular pressure member.

19. The apparatus of claim 1, comprising a pressurisation system which comprises the source of pressurised fluid, wherein the pressurisation system comprises an accumulator.

20. (canceled)

21. (canceled)

22. A method of testing a ring cut from a pipe using an apparatus, the method comprising:
a. cutting the ring from the pipe;
b. fitting the ring into the apparatus; and
c. applying pressure using the apparatus and recording the strain and deformation measurements;
wherein the apparatus includes:
a body,
an annular pressure member, which is expandable and is connected to a source of pressurised fluid, and
one or more sensors for measuring strain and deformation of the ring and fluid pressure,
wherein the body defines a substantially circular opening for receiving the annular pressure member and the ring, and the annular pressure member is provided, in use, between an inner surface of the substantially circular opening and an outer circular surface of the ring for applying pressure to the outer circular surface of the ring.
